(19) United States
(12) Patent Application Publication
(10) Pub. No.: US 2026/0342106 A1
(43) Pub. Date: Oct. 29, 2026

(54) CHARGING CONTROL METHOD AND ELECTRONIC DEVICE

(71) Applicant: Lenovo (Beijing) Limited, Beijing (CN)

(72) Inventors: Tong LI, Beijing (CN); Wentao XU, Beijing (CN); Jiguang TANG, Beijing (CN)

(21) Appl. No.: 19/649,992

(22) Filed: Apr. 16, 2026

(30) Foreign Application Priority Data
Apr. 24, 2025 (CN) 202510526617.5

(51) Int. Cl. H02J 7/00; H01M 10/44; H01M 10/46; H01M 50/267; H02J 7/50; H02J 7/90

(52) U.S. Cl. CPC H02J 7/485; H01M 10/441; H01M 10/443; H01M 10/46; H01M 50/267; H02J 7/50; H02J 7/975

(57) ABSTRACT

The present disclosure discloses an electronic device including a first body, a second body, a charging interface and a power manager. The first body includes at least one first charging apparatus and a first battery. The second body includes at least one second charging apparatus and a second battery. The first body and the second body are movable relative to each other, and the at least one first charging apparatus and the at least one second charging apparatus include charging apparatuses of a same type. The charging interface is configured to obtain power supplied by an external charging device. The power manager is configured to determine, from the at least one first charging apparatus and the at least one second charging apparatus based on parameter information of a virtual power apparatus, according to a target charging strategy, a target charging apparatus to charge the first battery and the second battery.

### CROSS-REFERENCES TO RELATED APPLICATIONS

The present disclosure claims priority to Chinese Patent Application No. 202510526617.5, filed on Apr. 24, 2025, the content of which is incorporated herein by reference in its entirety.

### TECHNICAL FIELD

The present disclosure relates to the field of device charging management, and more specifically, relates to a charging control method and an electronic device.

### BACKGROUND

A foldable device generally refers to a foldable-screen mobile phone, which is a product form of electronic devices such as mobile phones. In existing technology, charging technologies for batteries in foldable devices are mostly directly adopted from charging strategies used in bar-type devices (e.g., bar-type mobile phones). As a result, foldable devices are prone to prominent issues such as overheating during battery charging and low charging efficiency during the charging process.

### SUMMARY

One aspect of the present disclosure provides an electronic device including a first body, a second body, a charging interface and a power manager. The first body includes at least one first charging apparatus and a first battery. The second body includes at least one second charging apparatus and a second battery. The first body and the second body are movable relative to each other, and the at least one first charging apparatus and the at least one second charging apparatus include charging apparatuses of a same type. The charging interface is configured to obtain power supplied by an external charging device. The power manager is configured to determine, from the at least one first charging apparatus and the at least one second charging apparatus based on parameter information of a virtual power apparatus, according to a target charging strategy, a target charging apparatus to charge the first battery and the second battery.

Another aspect of the present disclosure provides a charging control method. The charging control method includes: determining, from at least one first charging apparatus and at least one second charging apparatus of an electronic device based on parameter information of a virtual power apparatus and according to a target charging strategy, a target charging apparatus; and, charging a first battery and a second battery of the electronic device based on the target charging apparatus. The at least one first charging apparatus is arranged on a first body of the electronic device, the at least one second charging apparatus is arranged on a second body of the electronic device, the first body and the second body are movable relative to each other, and the at least one first charging apparatus and the at least one second charging apparatus include charging apparatuses of a same type.

Yet another aspect of the present disclosure provides a non-transitory computer-readable storage medium storing instructions that, when executed by a processor, cause the processor to: determine, from at least one first charging apparatus and at least one second charging apparatus of an electronic device based on parameter information of a virtual power apparatus and according to a target charging strategy, a target charging apparatus; and, charge a first battery and a second battery of the electronic device based on the target charging apparatus. The at least one first charging apparatus is arranged on a first body of the electronic device, the at least one second charging apparatus is arranged on a second body of the electronic device, the first body and the second body are movable relative to each other, and the at least one first charging apparatus and the at least one second charging apparatus include charging apparatuses of a same type.

### BRIEF DESCRIPTION OF THE DRAWINGS

In order to more clearly illustrate the technical solutions in embodiments of the present disclosure or in related technologies, the accompanying drawings required for describing the embodiments or related technologies are briefly introduced below. It is apparent that the accompanying drawings described below merely illustrate some embodiments of the present disclosure, and those of ordinary skill in the art may obtain other drawings based on these drawings without creative efforts.

FIG. 1 illustrates a structural diagram of an electronic device in accordance with some embodiments of the present disclosure.

FIG. 2 illustrates an example hardware layout of a charging system of a foldable device in accordance with some embodiments of the present disclosure.

FIG. 3 illustrates a circuit schematic diagram of a charging system of a foldable device in accordance with some embodiments of the present disclosure.

FIG. 4 illustrates a schematic diagram of temperature partitioning of a foldable device in accordance with some embodiments of the present disclosure.

FIG. 5 illustrates an example flow diagram of charging control based on temperature control in accordance with some embodiments of the present disclosure.

FIG. 6 illustrates a schematic diagram of a charging path in a light-load mode in accordance with some embodiments of the present disclosure.

FIG. 7 illustrates a schematic diagram of a charging path in a heavy-load mode in accordance with some embodiments of the present disclosure.

FIG. 8 illustrates a schematic diagram of a charging path in a constant-voltage charging mode in accordance with some embodiments of the present disclosure.

FIG. 9 illustrates a system layered architecture diagram of a charging management system in accordance with some embodiments of the present disclosure.

FIG. 10 illustrates a corresponding software structure diagram of the charging management system in accordance with some embodiments of the present disclosure.

FIG. 11 illustrates a flowchart of a charging control method in accordance with some embodiments of the present disclosure.

### DETAILED DESCRIPTION

The following describes the technical solutions in embodiments of the present disclosure clearly and completely with reference to the accompanying drawings. It is apparent that the described embodiments are merely some embodiments of the present disclosure, rather than all embodiments. Based on the embodiments of the present disclosure, all other embodiments obtained by those of ordinary skill in the art without creative efforts shall fall within the scope of the present disclosure.

According to some embodiments of the present disclosure, a charging control method and an electronic device are provided, which are used to optimize battery charging technologies of electronic products having a foldable structure (i.e., foldable devices), so as to address issues such as overheating during charging and low charging efficiency that are likely to occur during battery charging of foldable devices (e.g., foldable-screen mobile phones).

The electronic device may be, but is not limited to, an electronic device under various general or special computing environments or configurations, for example: a personal computer, a server computer, a handheld device or portable device, a tablet device, a multi-processor device, etc.

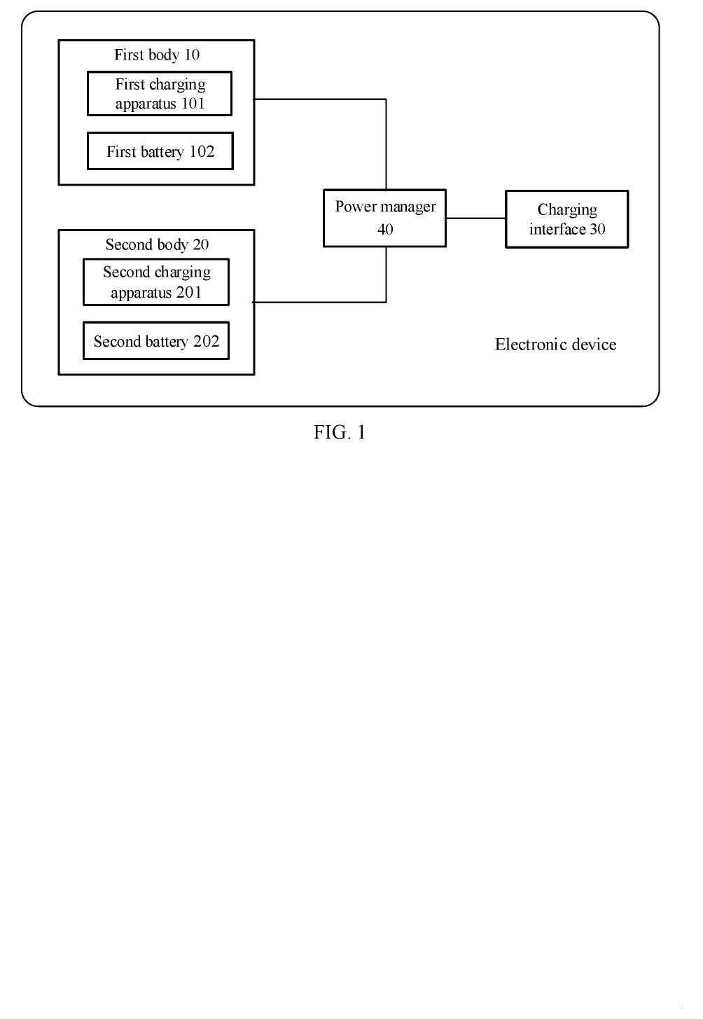

FIG. 1 illustrates a structural diagram of an electronic device in accordance with some embodiments of the present disclosure. The electronic device includes: a first body 10, a second body 20, a charging interface 30, and a power manager 40.

The first body 10 includes at least one first charging apparatus 101 and a first battery 102.

The second body 20 includes at least one second charging apparatus 201 and a second battery 202. The first body and the second body are movable relative to each other, and the at least one first charging apparatus and the at least one second charging apparatus include charging apparatuses of a same type.

That is, the electronic device in the embodiments of the present disclosure is a device having a foldable structure, including two bodies that are movable relative to each other, i.e., the first body and the second body.

Specially, the first body and the second body are connected through a connection apparatus, and the connection apparatus may include, but is not limited to, a hinge configured to connect the first body and the second body as a whole.

The first body and the second body may rotate about the hinge, and relative movement between the two bodies is generated through rotation about the hinge. During the relative movement between the two bodies, an included angle between the two bodies changes, such that the electronic device may form different device forms, such as an unfolded state where the two bodies are unfolded relative to each other, a folded state where the two bodies are folded relative to each other, or an intermediate state between the unfolded state and the folded state.

The foldable structure between the first body and the second body may refer to an up-down folding structure or a left-right folding structure, which is not limited and may depend on an actual structural design of the electronic device.

In the up-down folding structure, when the first body and the second body are unfolded, a length of the electronic device (e.g., a length of a mobile phone) is increased. In the left-right folding structure, when the first body and the second body are unfolded, a width of the electronic device (e.g., a width of a mobile phone) is increased.

To optimize charging technology of the foldable electronic device, in the embodiments of the present disclosure, the battery of the device is designed as a dual-battery configuration. That is, the battery of the electronic device includes the first battery and the second battery. The two batteries are respectively arranged on different bodies of the device. Specifically, the first battery is arranged on the first body, and the second battery is arranged on the second body, so as to avoid heat accumulation of the batteries during charging.

Similarly to the battery arrangement, the charging apparatuses of the electronic device are not arranged in an integrated manner, but are designed to include a first charging apparatus and a second charging apparatus, which are arranged on different bodies of the electronic device. Specifically, the first charging apparatus is arranged on the first body, and the second charging apparatus is arranged on the second body, so as to adapt to an internal foldable structure of the electronic device while addressing issues such as overheating during charging and low charging efficiency.

The at least one first charging apparatus includes a first-type charging apparatus and a second-type charging apparatus; and the at least one second charging apparatus includes the second-type charging apparatus and a third-type charging apparatus. Different types of charging apparatuses may correspond to different types of charging management chips, which are collectively referred to as charging ICs in the embodiments of the present disclosure.

Different charging ICs correspond to different charging paths and may charge the first battery and the second battery through corresponding charging paths.

Specifically, the first-type charging apparatus includes a PMIC (Power Management Integrated Circuit) charging IC, the second-type charging apparatus includes a CP (Charge Pump) charging IC, and the third-type charging apparatus includes a Buck charging IC.

For convenience of distinction, the CP charging IC on the first body is referred to as a CP1 charging IC, and the CP charging IC on the second body is referred to as a CP2 charging IC.

The Buck charging IC is an integrated circuit configured to convert an input direct-current voltage into a lower direct-current voltage and is mainly used for power management. A core function of the Buck charging IC is efficient step-down conversion while reducing energy loss, and it is widely applied in scenarios requiring stable low-voltage power supply.

The charging interface is configured to obtain power supplied by an external charging device, so as to charge the battery of the electronic device through an external charging device such as an AC charger.

The charging interface may include, but is not limited to, a wired charging interface such as a Type-C interface or a Thunderbolt interface or may also include a wireless charging interface.

The power manager is configured to determine, from the at least one first charging apparatus and the at least one second charging apparatus based on parameter information of a virtual power apparatus and according to a target charging strategy, a target charging apparatus to charge the first battery and the second battery.

The power manager may be a controller or a processor, and required functions may be implemented through corresponding software algorithms.

In the embodiments of the present disclosure, during charging of the first battery and the second battery, or during supplying power to system circuits of the electronic device using the first battery and the second battery, the first battery and the second battery are treated as a virtual integrated power source, i.e., the virtual power apparatus. In this manner, for a charging system or a power supply system of the electronic device, during charging and discharging of the batteries, it is not required to obtain a state of each battery, and charging/discharging of each battery is not separately controlled by a PMIC or other power management chips. Instead, the first battery and the second battery are treated as an integrated power source for unified charging and discharging management, thereby shielding internal dual-battery processing details and simplifying control logic of the overall system for charging heterogeneous batteries.

The parameter information of the virtual power apparatus may include relevant charging parameters corresponding to the virtual power apparatus formed by the first battery and the second battery during charging. Specifically, the parameter information may include current, voltage, and/or temperature information during charging, which may be obtained by integrating first charging parameters of the first battery and second charging parameters of the second battery.

The first charging parameters of the first battery may include, but are not limited to, charging current, voltage, and/or temperature of the first battery. The second charging parameters of the second battery may include, but are not limited to, charging current, voltage, and/or temperature of the second battery.

In implementation, the power manager may read first charging parameters such as current, voltage, and temperature of the first battery from a gauge of the first battery, and read second charging parameters such as current, voltage, and temperature of the second battery from a gauge of the second battery. Then, based on an integration algorithm, the parameter information of the virtual power apparatus is obtained by integrating the first charging parameters and the second charging parameters. Based on the parameter information of the virtual power apparatus, the target charging apparatus is determined from the at least one first charging apparatus and the at least one second charging apparatus according to a target charging strategy to charge the first battery and the second battery.

The charging process of a battery generally includes a plurality of stages, such as a constant-current stage, a constant-voltage stage, a fast-charging stage, or a trickle-charging stage. Different charging stages usually correspond to respective charging parameter requirements/specifications. The target charging strategy may include strategies configured to perform charging path switching or charging parameter adjustment based on charging parameter requirements/specifications of each charging stage.

Specifically, the power manager may determine charging demand information corresponding to the virtual power apparatus based on parameter information during charging and charging parameter requirements/specifications of a current charging stage. For example, the charging demand information may indicate which charging paths are required and whether it is required to increase charging voltage/current of certain charging paths. Based on the charging demand information, the power manager selects, from the at least one first charging apparatus and the at least one second charging apparatus, a target charging apparatus matching the charging demand information, thereby forming a required charging path and charging the first battery and the second battery with required charging parameters.

For example, during a fast-charging stage, in order to achieve rapid charging while considering heat dissipation requirements, the PMIC charging IC and CP1 charging IC on the first body and the CP2 charging IC on the second body may be selected as the target charging apparatus, such that multi-path charging is implemented and heat generated during charging is distributed across different charging paths, thereby avoiding overheating. During a trickle-charging stage, a smaller number of charging apparatuses, such as the PMIC charging IC on the first body or the CP2 charging IC on the second body, may be selected as the target charging apparatus, and corresponding charging parameters (e.g., small current) are controlled to implement trickle charging.

After the target charging apparatus is determined, for example, after a combination of charging ICs is determined, the power manager may perform dynamic charging path switching and charging parameter control, such that the first battery and the second battery are charged using charging paths and parameters that satisfy current charging requirements.

In existing technology, charging technologies for foldable devices are mostly directly adopted from charging strategies of bar-type devices without optimization for characteristics unique to foldable devices. Foldable devices have smaller volumes and more compact internal spaces, resulting in poorer heat dissipation. In addition, due to foldable structures, internal component layouts differ significantly from those of bar-type devices, resulting in more complex heat distribution during charging. However, existing technology does not provide charging solutions adapted to these characteristics, resulting in issues such as overheating and low charging efficiency.

To address the above problems, according to some embodiments of the present disclosure, based on a unique foldable structure of a foldable electronic device, a charging system is reconstructed at a hardware level. Batteries and charging apparatuses are designed separately, such as a dual-battery configuration and different charging apparatuses arranged on different bodies. The power manager is configured with charging management functions matching the hardware structure, such that the power manager may select a required combination of charging apparatuses (i.e., the target charging apparatus) from a plurality of distributed charging apparatuses and satisfy current charging requirements through dynamic path switching and/or charging parameter control, thereby balancing charging speed and heat dissipation.

The embodiments of the present disclosure provide two sets of charging apparatuses, which are arranged and distributed across two circuit boards of the electronic device (e.g., circuit boards included in a first body and a second body, respectively). The plurality of charging paths formed by the two sets of charging apparatuses may support simultaneous charging, and charging currents from the plurality of charging paths may be combined to charge dual batteries. Compared with a configuration in existing technology where charging apparatuses are arranged only on a main board to charge two batteries (e.g., in series), which generates a large amount of heat and increases the temperature of the main board, each charging apparatus in the present disclosure generates relatively less heat during charging. That is, the charging structure of the present disclosure distributes charging tasks across a plurality of paths, such that each path undertakes a portion of the charging task, thereby reducing heat generation. Charging apparatuses arranged at different positions and corresponding charging paths share the charging task of the dual batteries as required, while generating less heat individually and distributing heat across different regions of the device, thereby achieving a balance between charging speed and heat dissipation.

Particularly in heavy-load scenarios, compared with similar products in existing technology, foldable devices implementing the present disclosure exhibit improved charging performance. By combining and utilizing a plurality of charging paths corresponding to distributed charging apparatuses, fast charging requirements may be satisfied while avoiding device overheating, thereby effectively supporting high-load scenarios such as gaming and video playback and achieving faster and more stable charging.

In some embodiments, the first battery and the second battery are connected in parallel through a flexible printed cable crossing a connection apparatus. The connection apparatus, such as a hinge, is configured to movably connect the first body and the second body of the electronic device.

The flexible printed cable crossing the connection apparatus includes a first charging line and a second charging line.

A first end of the first charging line is connected to the charging interface. Each first charging apparatus is connected to the first charging line and the second charging line, and each second charging apparatus is connected to the first charging line and the second charging line. The second charging line is connected to a first power access point and a second power access point, where the first power access point corresponds to the first battery and the second power access point corresponds to the second battery.

The first charging line and the second charging line may include flexible connection lines crossing the hinge or other connection apparatuses, such as connection lines formed by a flexible printed circuit (FPC).

The first body further includes a first circuit board, and the first battery is connected to the first circuit board to form a first path on the first circuit board, where the first path is connected to the first power access point.

The second body further includes a second circuit board, and the second battery is connected to the second circuit board to form a second path on the second circuit board, where the second path is connected to the second power access point.

A capacity of the second battery is greater than a capacity of the first battery, and a size of the first circuit board is greater than a size of the second circuit board.

Battery capacity is generally positively correlated with battery size. According to some embodiments of the present disclosure, by arranging a relatively smaller-capacity first battery with a larger first circuit board in the first body, and arranging a larger-capacity second battery with a smaller second circuit board in the second body, hardware layout space of the electronic device may be efficiently utilized, thereby achieving optimized hardware layout.

The first path and the second path are connected in parallel through the flexible printed cable crossing the connection apparatus, for example, through the first charging line and the second charging line implemented using FPC.

The following describes an example in which the electronic device is a vertically foldable device.

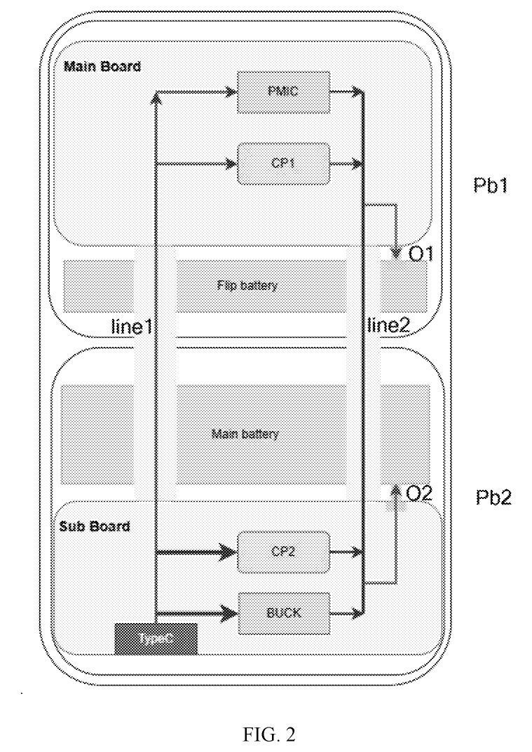

FIG. 2 illustrates a hardware layout of a charging system of a foldable device. In this example, the first body and the second body correspond to pb1 and pb2 in FIG. 2, respectively. The first body pb1 includes a first battery (Flip battery), a first circuit board (Main Board), a PMIC charging IC, and a CP1 charging IC. The second body pb2 includes a second battery (Main battery), a second circuit board (Sub Board), a CP2 charging IC, and a Buck charging IC. In addition, the second body pb2 may further include a charging interface such as a Type-C interface.

As shown in FIG. 2, the Main battery and the Flip battery are connected in parallel via a first connection line line1 and a second connection line line2 crossing the connection apparatus. One end of line1 is connected to the Type-C charging interface. Each charging apparatus (e.g., PMIC charging IC, CP1 charging IC, CP2 charging IC, and Buck charging IC) is respectively connected to line1 and line2. Line2 is connected to a first power access point O1 and a second power access point O2, where O1 corresponds to the first battery Flip battery and O2 corresponds to the second battery Main battery.

The Flip battery is connected to the Main Board to form a first path on the Main Board, and the first path is connected to the first power access point O1.

The Main battery is connected to the Sub Board to form a second path on the Sub Board, and the second path is connected to the second power access point O2. The first path and the second path are connected in parallel through line1 and line2.

Based on the above hardware layout, the first battery and the second battery form a parallel dual-battery structure. In the charging architecture, the first battery and the second battery are treated as a unified battery unit, i.e., the virtual power apparatus described above. Internal battery control logic of the virtual power apparatus is not exposed externally, such that the batteries may be managed as a unified power source for charging and discharging, thereby simplifying control of heterogeneous batteries.

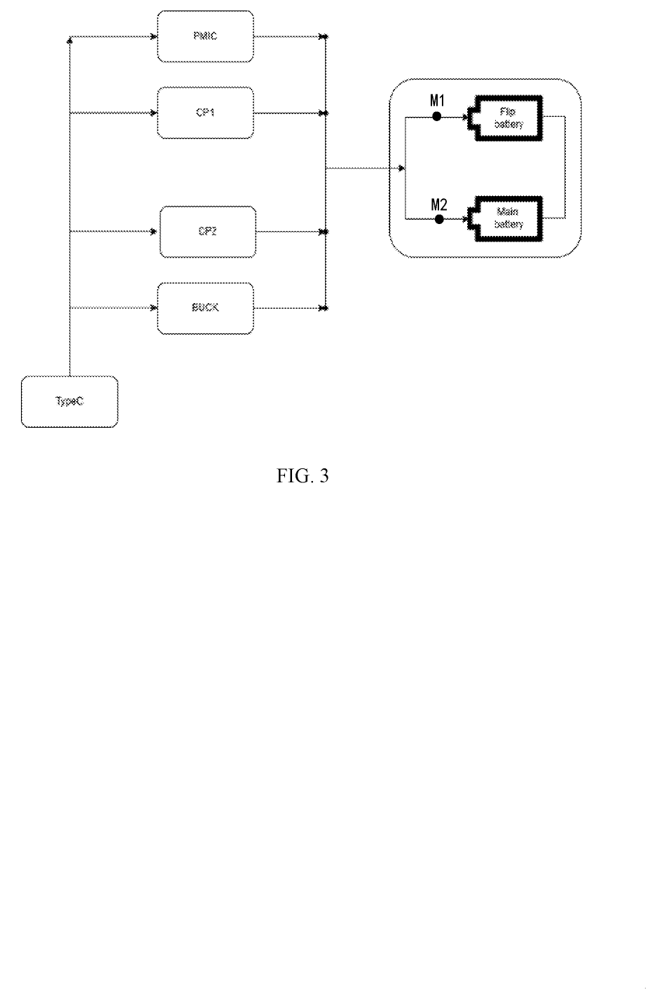

Within the virtual power apparatus, a respective control module, such as a control chip, may be provided for each battery, such that each battery may be independently charged and discharged as required via the corresponding control module. Referring to FIG. 3, a circuit schematic corresponding to the hardware layout of the charging system shown in FIG. 2 is further illustrated. Specifically, within the virtual power apparatus, a corresponding control module may be arranged along a path where each battery is located. For example, as shown in FIG. 3, a first control module M1 is arranged along a path where the Flip battery is located. The first control module M1 is connected to the Flip battery and the charging apparatuses. A second control module M2 is arranged along a path where the Main battery is located. The second control module M2 is connected between the Main battery and the charging apparatuses.

Within the virtual power apparatus, each battery may be independently controlled for charging and discharging as required based on a corresponding control module of the first battery and the second battery. For example, independent charging and discharging control of the Flip battery may be performed based on the first control module M1, and independent charging and discharging control of the Main battery may be performed based on the second control module M2. The independent charging and discharging control may include, but is not limited to, adjusting charging parameters (e.g., charging voltage and current) of a corresponding battery based on the control module, controlling the corresponding battery to stop charging, and adjusting discharge parameters of the corresponding battery when supplying power to a system.

That is, according to some embodiments of the present disclosure, in a foldable electronic device (e.g., a mobile phone, a tablet computer, or a laptop computer), two batteries having different capacities and arranged on two bodies are configured as independent batteries and are treated as a unified battery unit to form a virtual battery apparatus (battery system). The virtual battery apparatus may be charged via a charging network formed by charging apparatuses arranged on the two bodies (e.g., charging ICs such as a PMIC, a CP, or a Buck converter), thereby enabling charging of both batteries having different capacities. Further, within the virtual battery apparatus (battery system), each battery may be independently controlled for charging and discharging as required.

Further, within the virtual power apparatus, a third control module (which may also be a control chip) connected to the first battery and the second battery may be arranged. During a discharge process of the virtual power apparatus, the third control module may selectively disable a charging path corresponding to the first battery and/or the second battery as required, so as to prevent cross-charging between the two batteries due to a voltage difference therebetween, thereby avoiding potential safety risks and battery life degradation caused by such cross-charging.

Specifically, during a discharge process of the virtual power apparatus to supply power to a device system, the third control module may calculate a voltage difference between the first battery and the second battery. If an absolute value of the voltage difference does not reach a threshold, charging paths of the two batteries are not required to be disabled. In this case, each battery may discharge through a corresponding charging path and a discharge path. If the absolute value of the voltage difference reaches the threshold and a voltage of the first battery is higher than a voltage of the second battery, the third control module may disable a charging path corresponding to the first battery, so as to prevent the first battery from charging the second battery during the discharge process of the virtual power apparatus. If the absolute value of the voltage difference reaches the threshold and the voltage of the first battery is lower than the voltage of the second battery, the third control module may disable a charging path corresponding to the second battery, so as to prevent the second battery from charging the first battery during the discharge process of the virtual power apparatus. Through the above design, cross-charging between the two batteries caused by inconsistent voltages during discharge may be further prevented.

Based on the above design, according to some embodiments of the present disclosure, the charging system of the electronic device is reconstructed at a hardware level to accommodate a foldable structure of a foldable electronic device. Batteries and charging apparatuses are arranged in a separate manner, such as being configured as dual batteries and different charging apparatuses. Different batteries and different charging apparatuses are distributed across different bodies of the electronic device. Further, by configuring the power manager with charging management functions matching the hardware charging structure, the power manager may select a required charging apparatus combination (i.e., a target charging apparatus) from a plurality of distributed charging apparatuses and may perform dynamic path switching and charging parameter control to satisfy current charging requirements while balancing charging speed and heat dissipation.

Further, based on the above design, the present disclosure enables unified charging and discharging management of the first battery and the second battery as a single power source from a global system perspective, thereby shielding internal processing details of the dual batteries and simplifying control logic of the system for charging and discharging heterogeneous batteries. At the same time, within the virtual power apparatus, each battery may be independently controlled for charging and discharging based on corresponding control modules, thereby improving flexibility of dual-battery control, reducing safety risks, and improving battery lifetime.

In some embodiments of the present disclosure, the power manager may perform the following steps 11-12.

Step 11: obtaining a first value representing a temperature of the first body and a second value representing a temperature of the second body.

Based on the distributed hardware layout characteristics of the electronic device charging system described above, according to some embodiments of the present disclosure, the electronic device is further provided with a plurality of temperature monitoring regions, so as to perform battery charging control based on intelligent partitioned temperature control, thereby balancing charging speed and heat dissipation requirements.

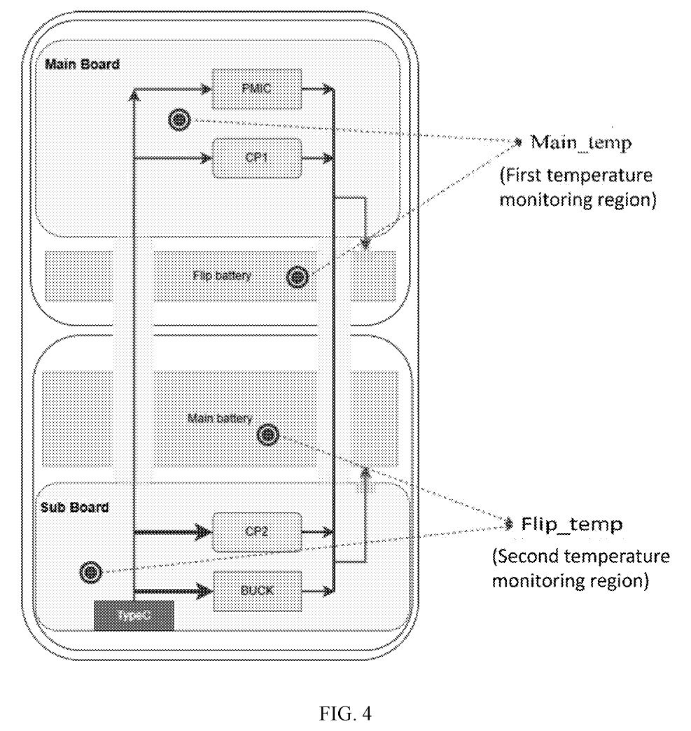

Referring to FIG. 4, which illustrates a schematic diagram of temperature partitioning of a foldable electronic device, regions formed by different bodies of the electronic device are configured as different temperature monitoring regions. For example, a region formed by the first body is configured as a first temperature monitoring region, and a region formed by the second body is configured as a second temperature monitoring region. Each temperature monitoring region may include one or more temperature sensing points. As shown in FIG. 4, each temperature monitoring region includes a plurality of temperature sensing points to reduce temperature detection error.

On this basis, temperature data at the sensing points in different bodies, i.e., different temperature monitoring regions, of the electronic device may be obtained via temperature sensors or other temperature detection components, so as to obtain a first value representing a temperature of the first body and a second value representing a temperature of the second body.

In a case where a plurality of temperature sensing points are arranged in a same temperature monitoring region, a weighted algorithm based on a thermal conduction model may be applied. Specifically, temperature data of the plurality of temperature sensing points within the same temperature monitoring region are weighted based on respective contributions of the sensing points in a thermal conduction process, and a weighted result is used as a temperature value of the temperature monitoring region. In this manner, a first value representing a temperature of the first body and a second value representing a temperature of the second body may be obtained.

Step 12: determining, based on the first value and the second value, a target charging apparatus from the at least one first charging apparatus and the at least one second charging apparatus according to a first charging strategy, so as to charge the first battery and the second battery.

The first charging strategy includes a strategy for performing battery charging control (e.g., path switching and charging parameter adjustment) based on temperatures of different temperature monitoring regions, i.e., temperatures of different bodies. For example, when a temperature of a particular body is relatively high, a number of charging paths on the particular body may be reduced or charging parameters may be lowered, thereby reducing the temperature of the particular body.

In some embodiments of the present disclosure, the power manager may determine a corresponding charging apparatus combination from the first-type charging apparatus, the second-type charging apparatus, and the third-type charging apparatus based on a first value representing a temperature of the first body and a second value representing a temperature of the second body, and use the charging apparatus combination as the target charging apparatus. For example, based on the first value and the second value, a corresponding charging apparatus combination may be selected from a PMIC charging IC and a CP1 charging IC on the first body, and a CP2 charging IC and a Buck charging IC on the second body, as the target charging apparatus.

The charging apparatus combination includes: a first combination corresponding to the first body and/or a second combination corresponding to the second body.

Based on the first charging strategy, a correspondence relationship among the first combination, the second combination, and temperature values of the bodies may include, but is not limited to, the following items 21–24.

Item 21: if the temperature of the first body is less than a first threshold, the first combination includes the first-type charging apparatus and the second-type charging apparatus on the first body.

Item 22: if the temperature of the first body reaches the first threshold, the first combination includes the first-type charging apparatus on the first body.

Item 23: if the temperature of the second body is below a second threshold, the second combination includes the second-type charging apparatus on the second body, and the second-type charging apparatus corresponds to a first charging current.

Item 24: if the temperature of the second body reaches the second threshold, the second combination includes the second-type charging apparatus on the second body, and the second-type charging apparatus corresponds to a second charging current. Where, the second charging current is lower than the first charging current; or, the second combination is empty.

That is, when a temperature of one of the first body or the second body is relatively high and reaches a corresponding threshold, a number of charging apparatuses used on the corresponding body may be reduced and/or charging parameters (e.g., charging current or voltage) of the charging apparatuses may be lowered, thereby reducing the temperature of the corresponding body and alleviating overheating during charging. At the same time, a number of charging apparatuses used on the other body may be increased and/or charging parameters of the charging apparatuses on the other body may be increased, so as to satisfy charging speed requirements of the batteries, thereby achieving a balance between charging speed and heat dissipation.

The following provides an application example of this embodiment.

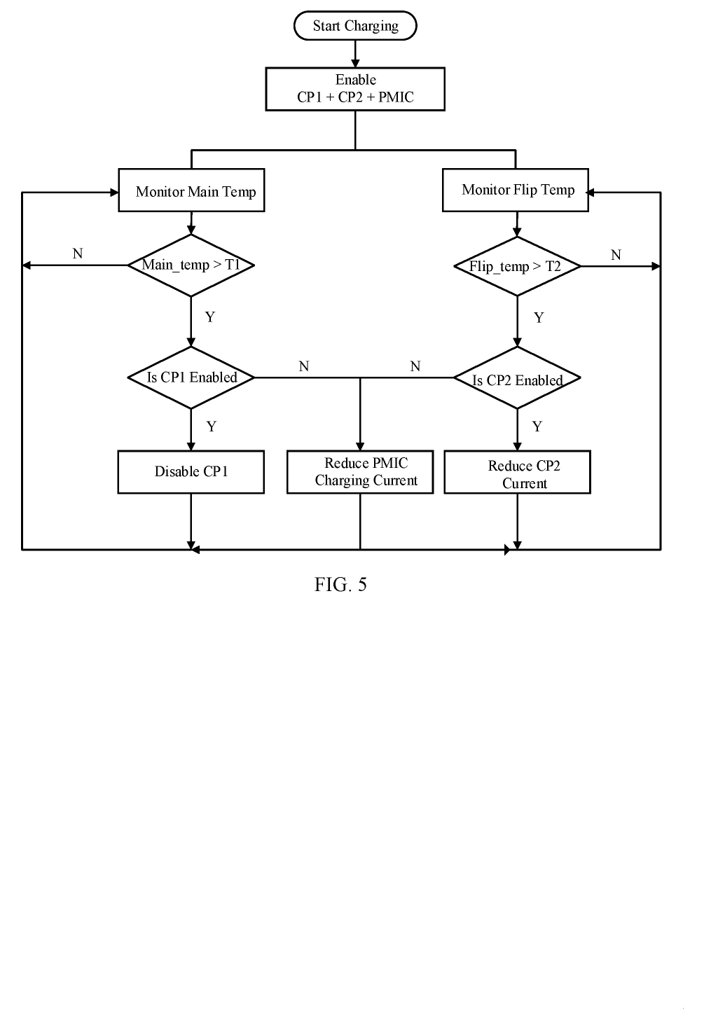

Referring to FIG. 5, which illustrates a schematic diagram of a charging control process in this example, when a first value Main_temp representing a temperature of the first body is less than a first threshold T1 and a second value Flip_temp representing a temperature of the second body is below a second threshold T2, a PMIC charging IC and a CP1 charging IC on the first body and a CP2 charging IC on the second body are used to charge the two batteries, thereby enabling fast charging of the device and reducing charging time.

Subsequently, during the charging process of the batteries, temperature changes of the first body (Main_temp) and the second body (Flip_temp) are monitored. When Main_temp reaches the first threshold T1, the CP1 charging IC may be disabled or a charging current of the PMIC charging IC may be reduced, as shown in FIG. 5, so as to reduce the temperature of the first body and alleviate overheating of the first body. When Flip_temp reaches the second threshold T2, as shown in FIG. 5, a charging current of the CP2 charging IC may be reduced to reduce the temperature of the second body and alleviate overheating of the second body. Alternatively, when the CP2 charging IC is not enabled, the charging current of the PMIC charging IC on the first body may be reduced, so as to indirectly reduce the temperature of the second body.

In practical applications, when performing charging control of the dual batteries based on intelligent partitioned temperature control, parameter information of the virtual power apparatus may be further considered. That is, parameter information of the virtual power apparatus and temperatures of different temperature monitoring regions are jointly considered, and based on these two types of information, a target charging apparatus is determined from the at least one first charging apparatus and the at least one second charging apparatus to charge the first battery and the second battery.

More specifically, parameter information of the virtual power apparatus, such as voltage, current, temperature, and state of charge, may be used to determine current charging requirement information of the virtual power apparatus. Combined with actual temperatures of different temperature monitoring regions formed by different bodies of the foldable electronic device, a target charging apparatus and a corresponding charging path may be selected such that the target charging apparatus both matches current charging requirements of the batteries and balances heat generation of the device. In this manner, charging of the dual batteries of the electronic device may be performed through path switching and corresponding charging parameter control.

In summary, according to some embodiments of the present disclosure, based on a distributed hardware layout characteristic of a charging system in a foldable electronic device, a plurality of temperature monitoring regions are arranged on the electronic device. Battery charging control based on intelligent partitioned temperature control and dynamic path switching is achieved, thereby effectively balancing charging speed and heat dissipation requirements and addressing issues such as charging overheating and low charging efficiency during battery charging of foldable devices.

In some embodiments of the present disclosure, the power manager may further be configured to perform the following processing steps 31–32.

Step 31: obtaining mode information representing an operating mode of the electronic device.

The operating mode refers to a runtime mode of the electronic device in a charging scenario, and may include, but is not limited to, a light-load mode, a heavy-load mode, and a constant-voltage charging mode.

In implementation, load state information and/or charging state information of the electronic device in the charging scenario may be monitored, and the operating mode of the electronic device in the charging scenario may be determined based on the monitored load state information and/or charging state information, such as a light-load mode when in a light-load state, a heavy-load mode when in a heavy-load state, or a constant-voltage charging mode when in a constant-voltage charging state.

Step 32: determining, based on the mode information, a target charging apparatus from the at least one first charging apparatus and the at least one second charging apparatus according to a second charging strategy, so as to charge the first battery and the second battery.

The second charging strategy includes a strategy for performing battery charging control (e.g., path switching and charging parameter adjustment) based on the operating mode of the electronic device. For example, in the light-load mode, a plurality of charging apparatuses on the first body and the second body may be selected as the target charging apparatus to achieve fast charging and reduce charging time. In the heavy-load mode, a number of charging apparatuses enabled on a body including high-power-consumption components may be reduced and/or charging parameters (e.g., charging current or voltage) may be lowered, so as to avoid overheating of the body. Meanwhile, charging apparatuses on the other body may be controlled to undertake a primary charging task, thereby maintaining charging speed in the heavy-load mode.

In this embodiment, the power manager may determine a corresponding charging apparatus combination from the first-type charging apparatus, the second-type charging apparatus, and the third-type charging apparatus based on mode information representing an operating mode of the electronic device, and use the charging apparatus combination as the target charging apparatus.

If the mode information indicates that the electronic device operates in a light-load mode, the charging apparatus combination includes the first-type charging apparatus and the second-type charging apparatus on the first body, and the second-type charging apparatus on the second body. If the mode information indicates that the electronic device operates in a heavy-load mode, the charging apparatus combination includes the first-type charging apparatus on the first body and the second-type charging apparatus on the second body. If the mode information indicates that the electronic device operates in a constant-voltage charging mode, the charging apparatus combination includes the first-type charging apparatus on the first body and the third-type charging apparatus on the second body.

The following describes, by way of example, a process of performing battery charging control based on an operating mode of the electronic device, where the first-type charging apparatus, the second-type charging apparatus, and the third-type charging apparatus are respectively a PMIC charging IC, a CP charging IC, and a Buck charging IC; a first circuit board on the first body and a second circuit board on the second body are respectively a Main Board and a Sub Board; and the first battery and the second battery are respectively a Flip Battery and a Main Battery.

### I. Light-Load Mode

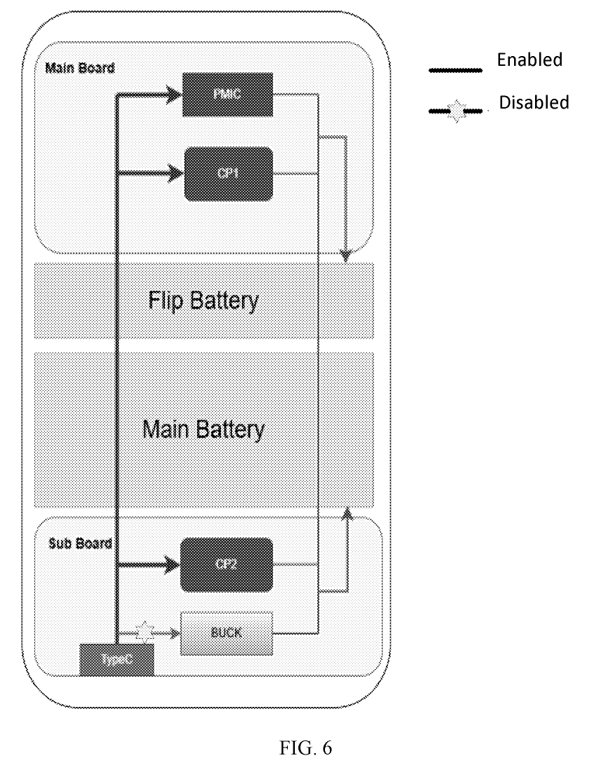

In a light-load mode, such as a standby mode, a PMIC charging IC and a CP1 charging IC on the first body and a CP2 charging IC on the second body are selected as the target charging apparatus. Referring to FIG. 6, a plurality of charging paths corresponding to the PMIC charging IC, the CP1 charging IC, and the CP2 charging IC may be enabled to charge the two batteries. This configuration enables fast charging of the device batteries, thereby reducing charging time.

In this configuration, as charging time progresses, the device may generate relatively high heat during charging. When higher heat is generated, the temperature-based intelligent charging control strategy described above may be activated to switch charging paths and/or adjust charging parameters, thereby reducing device temperature.

### II. Heavy-Load Mode

For example, a heavy-load mode corresponds to scenarios such as playing 4K video or running games.

In the heavy-load mode corresponding to scenarios such as playing 4K video or running games, core components of the electronic device, such as a central processing unit (CPU) and a graphics processing unit (GPU), operate at high frequencies and exhibit relatively high power consumption. These components are typically arranged on the Main Board, thereby causing the temperature of the Main Board to increase rapidly.

Based on this, on one hand, heat generation of the Main Board may be effectively reduced by disabling the CP1 charging IC on the first body where the Main Board is located, or by reducing a charging rate of the PMIC charging IC (e.g., reducing charging current and/or voltage), thereby maintaining the temperature of the Main Board at a stable and safe level. The charging rate of the PMIC charging IC may be reduced in a stepwise manner.

On the other hand, the CP2 charging IC on the Sub Board may undertake a primary charging task, for example, by increasing charging current and/or voltage of the CP2 charging IC, thereby ensuring that charging speed of the batteries is not adversely affected. This charging control scheme addresses issues in existing technology where charging current is too low or charging is not feasible in heavy-load scenarios, thereby improving user experience.

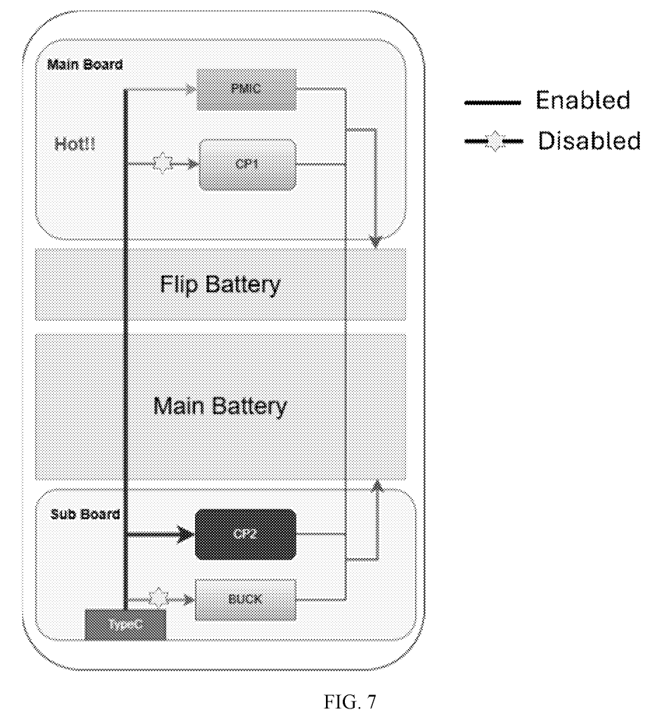

Referring to FIG. 7, an example is illustrated in which, upon detecting that the electronic device enters the heavy-load mode, the temperature of the Main Board is reduced by disabling the CP1 charging IC and/or reducing the charging current of the PMIC charging IC. In this example, in the heavy-load mode, the dual batteries are charged via two charging paths corresponding to the PMIC charging IC and the CP2 charging IC.

### III. Constant-Voltage Charging Mode

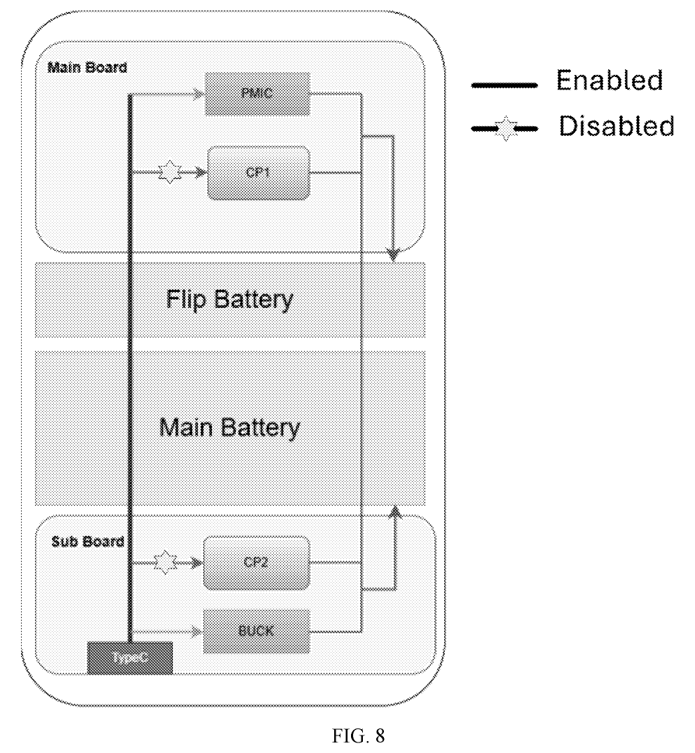

When a constant-voltage charging stage is entered, charging current gradually decreases and may not satisfy operating conditions for stable operation of a CP charging IC, such that the CP charging IC is in a non-operating state. In this case, if the Main Board is performing system operations, a charging current of the PMIC charging IC may be limited to a relatively low level, thereby making it difficult to satisfy charging speed requirements. Under such conditions, referring to FIG. 8, a charging path may be switched to a charging path corresponding to the PMIC charging IC and a charging path corresponding to the Buck charging IC, such that charging speed may be maintained by utilizing the charging path of the Buck charging IC.

In practical applications, when performing charging control of dual batteries based on an operating mode of the device, parameter information of the virtual power apparatus may be further considered. That is, parameter information of the virtual power apparatus and the operating mode of the device are jointly considered, and based on these two types of information, a target charging apparatus is determined from the at least one first charging apparatus and the at least one second charging apparatus to charge the first battery and the second battery.

More specifically, parameter information of the virtual power apparatus, such as voltage, current, temperature, and state of charge, may be used to determine current charging requirement information of the virtual power apparatus. Combined with an operating mode of the foldable electronic device, a target charging apparatus and a corresponding charging path may be selected such that the target charging apparatus both matches current charging requirements of the batteries and balances heat generation of the device under the current operating mode (e.g., in a heavy-load mode, the temperature of the Main Board may increase rapidly, resulting in a relatively high temperature of the Main Board). In this manner, charging of dual batteries of the electronic device may be achieved through path switching and corresponding charging parameter control.

Further, in practical applications, a charging control scheme based on intelligent partitioned temperature control as disclosed above and a charging control scheme based on operating modes may be used in combination, such that the charging process of batteries in the foldable electronic device is more adaptive and intelligent, thereby achieving a balance among charging speed, heat dissipation, and overall performance during charging.

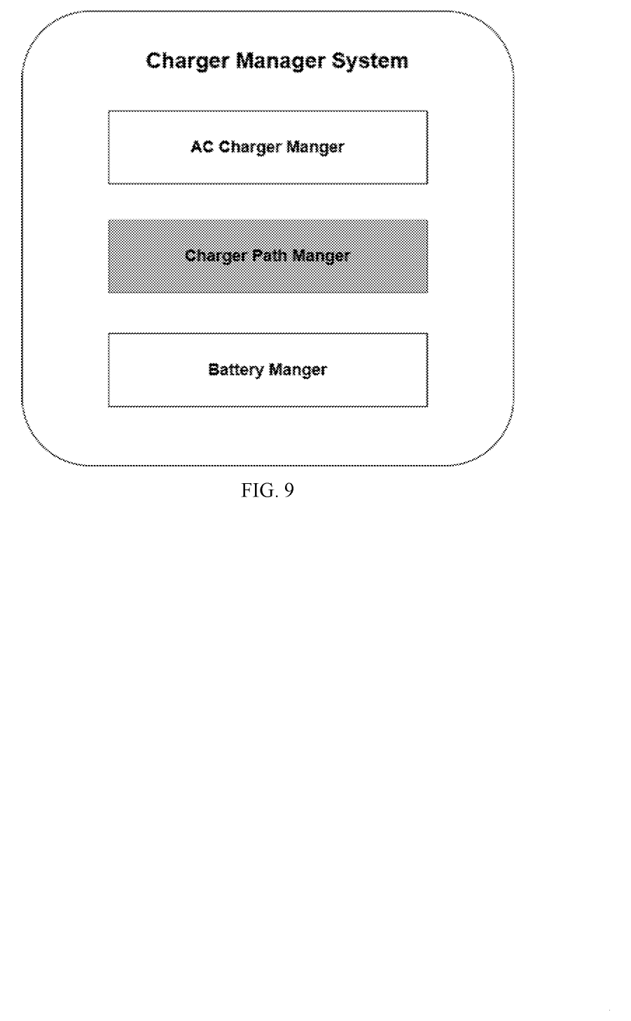

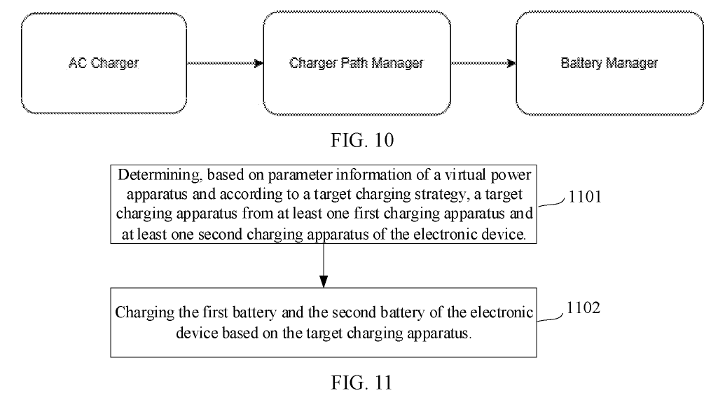

In practical applications, the present disclosure may be implemented using a charging management system including a charger manager, a charging path manager, and a battery manager. The charging management system and a corresponding charging software architecture are illustrated in FIG. 9 and FIG. 10, respectively, where an AC Charger Manager represents the charger manager, a Charger Path Manager represents the charging path manager, and a Battery Manager represents the battery manager.

The battery manager is configured to perform charging management for the first battery and the second battery. For example, the battery manager may obtain charging parameters of the dual batteries and integrate the charging parameters of the dual batteries to obtain parameter information of the virtual power apparatus, so as to manage the first battery and the second battery as a unified power apparatus from a global perspective. The charging path manager is configured to perform path switching and/or charging parameter adjustment control based on parameter information of the virtual power apparatus obtained by the battery manager, and may further consider temperatures of different temperature monitoring regions, an operating mode of the device, and the like. The charger manager is configured to control output parameters of a charger so as to satisfy charging requirements of the batteries.

According to some embodiments of the present disclosure, by performing dynamic path switching and/or charging parameter adjustment based on an operating mode of the electronic device in a charging scenario, the solution may adapt to an actual operating mode of the electronic device to effectively balance charging speed and heat dissipation requirements of the batteries, thereby addressing issues such as charging overheating and low charging efficiency in foldable devices. In particular, the solution addresses issues in existing technology where charging current is insufficient or charging is not feasible in heavy-load scenarios, thereby improving user experience.

Corresponding to the electronic device described above, some embodiments of the present disclosure further provide a charging control method. Referring to FIG. 11, the charging control method may include the following steps 1101–1102.

Step 1101: determining, based on parameter information of a virtual power apparatus and according to a target charging strategy, a target charging apparatus from at least one first charging apparatus and at least one second charging apparatus of the electronic device.

The target charging strategy may include a strategy configured to perform parameter adjustment and/or control of a charging process based on charging parameter requirements or specifications of different charging stages.

Step 1102: charging the first battery and the second battery of the electronic device based on the target charging apparatus.

The at least one first charging apparatus is arranged on the first body of the electronic device, and the at least one second charging apparatus is arranged on the second body of the electronic device. The first body and the second body are movable relative to each other, and the at least one first charging apparatus and the at least one second charging apparatus include charging apparatuses of a same type.

Specifically, steps 1101–1102 may be performed by the power manager.

In some embodiments of the present disclosure, step 1101 described above, i.e., determining the target charging apparatus from the at least one first charging apparatus and the at least one second charging apparatus based on parameter information of the virtual power apparatus and according to a target charging strategy, may include at least one of the following steps 41–42.

Step 41: obtaining a first value representing a temperature of the first body and a second value representing a temperature of the second body, and determining, based on the first value and the second value and according to a first charging strategy, the target charging apparatus from the at least one first charging apparatus and the at least one second charging apparatus to charge the first battery and the second battery.

The first charging strategy includes a strategy for performing battery charging control (e.g., path switching and charging parameter adjustment) based on temperatures of different temperature monitoring regions, i.e., temperatures of different bodies. For example, when a temperature of a particular body is relatively high, a number of charging paths on the particular body may be reduced and/or charging parameters may be lowered, so as to reduce the temperature of the particular body.

In practical applications, when performing charging control of dual batteries based on temperature control (e.g., intelligent partitioned temperature control) according to the first charging strategy, parameter information of the virtual power apparatus may be further considered. That is, parameter information of the virtual power apparatus and temperatures of different temperature monitoring regions may be jointly considered, and based on these two types of information, a target charging apparatus is determined from the at least one first charging apparatus and the at least one second charging apparatus to charge the first battery and the second battery.

More specifically, parameter information of the virtual power apparatus, such as voltage, current, temperature, and state of charge, may be used to determine current charging requirement information of the virtual power apparatus. Combined with actual temperatures of different temperature monitoring regions formed by different bodies of the foldable electronic device, a target charging apparatus and a corresponding charging path may be selected such that the target charging apparatus both matches current charging requirements of the batteries and balances heat generation of the device. In this manner, charging of the dual batteries of the electronic device may be achieved through path switching and corresponding charging parameter control.

Step 42: obtaining mode information representing an operating mode of the electronic device; and determining, based on the mode information and according to a second charging strategy, a target charging apparatus from the at least one first charging apparatus and the at least one second charging apparatus to charge the first battery and the second battery.

The processes of steps 41 and 42 may likewise be performed by the power manager.

The second charging strategy includes a strategy for performing battery charging control (e.g., path switching and charging parameter adjustment) based on the operating mode of the electronic device. For example, in a light-load mode, a plurality of charging apparatuses on the first body and the second body may be selected as the target charging apparatus to achieve fast charging and reduce charging time. In a heavy-load mode, a number of charging apparatuses enabled on a body including high-power-consumption components, such as a CPU or a GPU, may be reduced and/or charging parameters of the charging apparatuses may be lowered to avoid overheating of that body. Meanwhile, charging apparatuses on another body may be controlled to undertake a primary charging task, thereby maintaining charging speed in the heavy-load mode.

In practical applications, when performing charging control of dual batteries based on an operating mode of the device, parameter information of the virtual power apparatus may be further considered. That is, parameter information of the virtual power apparatus and the operating mode of the device may be jointly considered, and based on these two types of information, a target charging apparatus is determined from the at least one first charging apparatus and the at least one second charging apparatus to charge the first battery and the second battery.

More specifically, parameter information of the virtual power apparatus, such as voltage, current, temperature, and state of charge, may be used to determine current charging requirement information of the virtual power apparatus. Combined with an operating mode of the foldable electronic device, a target charging apparatus and a corresponding charging path may be selected such that the target charging apparatus both matches current charging requirements of the batteries and balances heat generation of the device under the current operating mode (e.g., in a heavy-load mode, the temperature of the Main Board may increase rapidly, resulting in a relatively high temperature of the Main Board). In this manner, charging of the dual batteries of the electronic device may be achieved through path switching and corresponding charging parameter control.

Further, in practical applications, a charging control scheme based on intelligent partitioned temperature control as disclosed above and a charging control scheme based on operating modes may be used in combination, such that the charging process of batteries in the foldable electronic device is more adaptive and intelligent, thereby achieving a balance among charging speed, heat dissipation, and overall performance during charging.

The charging control method provided in this embodiment corresponds to the electronic device described in the foregoing embodiments. For more detailed implementations of each step of the charging control method, reference may be made to the corresponding descriptions of the electronic device above, and details are not repeated herein.

According to some embodiments of the present disclosure, based on a unique foldable structure of a foldable electronic device, a charging system of the electronic device is reconstructed at a hardware level. Batteries of the device and charging apparatuses of the batteries are arranged in a separate manner, for example, configured as dual batteries and different charging apparatuses, and distributed across different bodies of the electronic device. Further, by configuring a power manager with charging management functions corresponding to the hardware charging structure, the power manager may select a required charging apparatus combination (i.e., a target charging apparatus) from a plurality of distributed charging apparatuses, and may perform dynamic path switching and charging parameter control to satisfy current charging requirements while balancing charging speed and heat dissipation.

In particular, in heavy-load scenarios, compared with similar products in existing technology, foldable devices implementing the present disclosure may exhibit improved charging performance. By selectively utilizing a plurality of charging paths corresponding to distributed charging apparatuses, fast charging requirements may be satisfied while mitigating device overheating. Accordingly, the present disclosure may effectively support high-load scenarios, such as gaming and video playback, thereby enabling faster and more stable charging.

It should be noted that the embodiments described in this specification are presented in a progressive manner, and each embodiment focuses on differences from other embodiments. Similar or identical features among the embodiments may be referenced from one another.

For convenience of description, the above-described systems or apparatuses are described in terms of functional modules or units. However, in implementing the present disclosure, functions of the respective modules or units may be implemented in a single or in a plurality of software and/or hardware components.

From the foregoing description of the embodiments, those of ordinary skill in the art will readily understand that the present disclosure may be implemented in the form of software in combination with a necessary general-purpose hardware platform. Based on such understanding, the technical solutions of the present disclosure, or a portion thereof that contributes to the inventive aspects, may be embodied in the form of a software product. The software product may be stored in a storage medium, such as a read-only memory (ROM), a random access memory (RAM), a magnetic disk, an optical disc, or the like, and may include a plurality of instructions for causing a computing device (such as a personal computer, a server, or a network device) to perform the methods described in the respective embodiments or portions thereof.

Finally, it should be noted that relational terms such as “first,” “second,” “third,” and “fourth” are used herein only to distinguish one entity or operation from another, and do not necessarily require or imply any actual relationship or order between such entities or operations. Moreover, the terms “include,” “including,” or any variations thereof are intended to cover a non-exclusive inclusion, such that a process, method, article, or apparatus that includes a list of elements not only includes those elements but may also include other elements not expressly listed or inherent to such process, method, article, or apparatus. Without further limitation, an element defined by the phrase “including a …” does not preclude the presence of additional identical elements in the process, method, article, or apparatus that includes the element.

The above descriptions are merely preferred embodiments of the present disclosure. It should be noted that those skilled in the art may make various modifications and refinements without departing from the principles of the present disclosure, and such modifications and refinements are intended to fall within the scope of the present disclosure.

What is claimed is:

1. An electronic device, comprising:
a first body comprising at least one first charging apparatus and a first battery;
a second body comprising at least one second charging apparatus and a second battery, wherein the first body and the second body are movable relative to each other, and the at least one first charging apparatus and the at least one second charging apparatus comprise charging apparatuses of a same type;
a charging interface configured to obtain power supplied by an external charging device; and
a power manager configured to determine, from the at least one first charging apparatus and the at least one second charging apparatus based on parameter information of a virtual power apparatus and according to a target charging strategy, a target charging apparatus to charge the first battery and the second battery.

2. The electronic device according to claim 1, wherein
the first battery and the second battery are connected in parallel through a flexible printed cable crossing a connection apparatus, and the connection apparatus is configured to movably connect the first body and the second body; and
the flexible printed cable crossing the connection apparatus comprises a first charging line and a second charging line, a first end of the first charging line is connected to the charging interface, each first charging apparatus is respectively connected to the first charging line and the second charging line, each second charging apparatus is respectively connected to the first charging line and the second charging line, and the second charging line is connected to a first power access point and a second power access point, wherein the first power access point corresponds to the first battery, and the second power access point corresponds to the second battery.

3. The electronic device according to claim 2, wherein the power manager is further configured to:
obtain a first value representing a temperature of the first body and a second value representing a temperature of the second body; and
determine, from the at least one first charging apparatus and the at least one second charging apparatus according to a first charging strategy based on the first value and the second value, the target charging apparatus to charge the first battery and the second battery.

4. The electronic device according to claim 2, wherein the power manager is further configured to:
obtain mode information representing an operating mode of the electronic device; and
determine, from the at least one first charging apparatus and the at least one second charging apparatus according to a second charging strategy based on the mode information, the target charging apparatus to charge the first battery and the second battery.

5. The electronic device according to claim 2, wherein
the first body further comprises a first circuit board, the first battery is connected to the first circuit board to form a first path on the first circuit board, and the first path is connected to the first power access point;
the second body further comprises a second circuit board, the second battery is connected to the second circuit board to form a second path on the second circuit board, and the second path is connected to the second power access point; and
a capacity of the second battery is greater than a capacity of the first battery, and the first path and the second path are connected in parallel through the flexible printed cable crossing the connection apparatus.

6. The electronic device according to claim 5, wherein
the at least one first charging apparatus is arranged on the first circuit board, and the at least one first charging apparatus comprises a first-type charging apparatus and a second-type charging apparatus; and
the at least one second charging apparatus is arranged on the second circuit board, and the at least one second charging apparatus comprises the second-type charging apparatus and a third-type charging apparatus.

7. The electronic device according to claim 6, wherein
the target charging apparatus comprises a charging-apparatus combination determined from the first-type charging apparatus, the second-type charging apparatus, and the third-type charging apparatus according to a first value representing a temperature of the first body and a second value representing a temperature of the second body; and
the charging-apparatus combination comprises a first combination corresponding to the first body and/or a second combination corresponding to the second body, wherein
in response to the temperature of the first body being less than a first threshold, the first combination comprises the first-type charging apparatus and the second-type charging apparatus on the first body;
in response to the temperature of the first body reaching the first threshold, the first combination comprises the first-type charging apparatus on the first body;
in response to the temperature of the second body being less than a second threshold, the second combination comprises the second-type charging apparatus on the second body, the second-type charging apparatus corresponding to a first charging current; and
in response to the temperature of the second body reaching the second threshold, the second combination comprises the second-type charging apparatus on the second body, the second-type charging apparatus corresponding to a second charging current, wherein
the second charging current is lower than the first charging current; or
the second combination is empty.

8. The electronic device according to claim 6, wherein the target charging apparatus comprises a charging-apparatus combination determined from the first-type charging apparatus, the second-type charging apparatus, and the third-type charging apparatus according to mode information of the electronic device, the mode information representing an operating mode of the electronic device, wherein
in response to the mode information indicating that the electronic device operates in a light-load mode, the charging-apparatus combination comprises the first-type charging apparatus and the second-type charging apparatus on the first body, and the second-type charging apparatus on the second body;
in response to the mode information indicating that the electronic device operates in a heavy-load mode, the charging-apparatus combination comprises the first-type charging apparatus on the first body and the second-type charging apparatus on the second body; and
in response to the mode information indicating that the electronic device operates in a constant-voltage charging mode, the charging-apparatus combination comprises the first-type charging apparatus on the first body and the third-type charging apparatus on the second body.

9. A charging control method, comprising:
determining, from at least one first charging apparatus and at least one second charging apparatus of an electronic device based on parameter information of a virtual power apparatus and according to a target charging strategy, a target charging apparatus; and
charging a first battery and a second battery of the electronic device based on the target charging apparatus,
wherein the at least one first charging apparatus is arranged on a first body of the electronic device, the at least one second charging apparatus is arranged on a second body of the electronic device, the first body and the second body are movable relative to each other, and the at least one first charging apparatus and the at least one second charging apparatus comprise charging apparatuses of a same type.

10. The charging control method according to claim 9, wherein determining, from the at least one first charging apparatus and the at least one second charging apparatus of the electronic device based on the parameter information of the virtual power apparatus and according to the target charging strategy, the target charging apparatus comprises at least one of:
obtaining a first value representing a temperature of the first body and a second value representing a temperature of the second body, and determining, from the at least one first charging apparatus and the at least one second charging apparatus according to a first charging strategy based on the first value and the second value, the target charging apparatus to charge the first battery and the second battery; and
obtaining mode information representing an operating mode of the electronic device, and determining, from the at least one first charging apparatus and the at least one second charging apparatus according to a second charging strategy based on the mode information, the target charging apparatus to charge the first battery and the second battery.

11. The charging control method according to claim 10, wherein obtaining the first value and the second value comprises:
obtaining temperature data of the first body and the second body from a plurality of temperature sensing points.

12. The charging control method according to claim 11, wherein obtaining the first value and the second value further comprises:
performing a weighted calculation on the temperature data to obtain the first value and the second value.

13. The charging control method according to claim 10, wherein obtaining the mode information comprises:
determining the mode information based on at least one of load state information or charging state information of the electronic device.

14. The charging control method according to claim 13, wherein determining the target charging apparatus according to the second charging strategy based on the mode information comprises:
in response to the electronic device operating in a heavy-load mode, reducing a number of charging apparatuses enabled on one of the first body or the second body, and increasing a charging contribution of charging apparatuses on another of the first body or the second body.

15. A non-transitory computer-readable storage medium storing instructions that, when executed by a processor, cause the processor to:
determine, from at least one first charging apparatus and at least one second charging apparatus of an electronic device based on parameter information of a virtual power apparatus and according to a target charging strategy, a target charging apparatus; and
charge a first battery and a second battery of the electronic device based on the target charging apparatus,
wherein the at least one first charging apparatus is arranged on a first body of the electronic device, the at least one second charging apparatus is arranged on a second body of the electronic device, the first body and the second body are movable relative to each other, and the at least one first charging apparatus and the at least one second charging apparatus comprise charging apparatuses of a same type.

16. The non-transitory computer-readable storage medium according to claim 15, wherein
the instructions cause the processor to:
obtain a first value representing a temperature of the first body and a second value representing a temperature of the second body; and
determine the target charging apparatus according to a first charging strategy based on the first value and the second value.

17. The non-transitory computer-readable storage medium according to claim 15, wherein
the instructions cause the processor to:
obtain mode information representing an operating mode of the electronic device; and
determine the target charging apparatus according to a second charging strategy based on the mode information.

18. The non-transitory computer-readable storage medium according to claim 16, wherein
the instructions cause the processor to determine the first value and the second value based on temperature data from a plurality of temperature sensing points.

19. The non-transitory computer-readable storage medium according to claim 17, wherein
the instructions cause the processor to select a charging apparatus combination from a first-type charging apparatus, a second-type charging apparatus, and a third-type charging apparatus.

20. The non-transitory computer-readable storage medium according to claim 17, wherein
the instructions cause the processor to:
determine charging requirement information based on parameter information of a virtual power apparatus; and
determine the target charging apparatus based on both the parameter information and the mode information.
